(19) United States
(12) Patent Application Publication
(10) Pub. No.: US 2026/0291789 A1
(43) Pub. Date: Sep. 24, 2026

(54) RECEIVER FOR BACKGROUND ADAPTATION TO PLURALITY OF PARAMETERS, METHOD OF OPERATING RECEIVER, AND SYSTEM INCLUDING RECEIVER

(71) Applicant: Samsung Electronics Co., Ltd., Suwon-si (KR)

(72) Inventors: Minjae LEE, Gwangju-si (KR); Yang AZEVEDO TAVARES, Gwangju-si (KR)

(73) Assignees: Samsung Electronics Co., Ltd., Suwon-si (KR); GWANGJU INSTITUTE OF SCIENCE AND TECHNOLOGY, Gwangju (KR)

(21) Appl. No.: 19/560,620

(22) Filed: Mar. 9, 2026

(30) Foreign Application Priority Data
Mar. 19, 2025 (KR) 10-2025-0035525

(51) Int. Cl. H04L 27/01; H04L 27/26

(52) U.S. Cl. CPC H04L 27/01; H04L 27/2671; H04L 27/2679

(57) ABSTRACT

A receiver includes a CTLE circuit configured to generate an equalization signal by performing first equalization on a received signal based on a first source resistor and a first source capacitor, an ADC configured to sample the equalization signal and generate a plurality of sampling symbols, a decision feedback equalizer (DFE) configured to generate a plurality of estimated symbols corresponding to the equalization signal by respectively subtracting residuals of previous sampling symbols from the plurality of sampling symbols, and a parameter adjustment circuit configured, in a first cycle based on the plurality of estimated symbols, to adjust the first source resistor such that a value of a first post tap converges to a first preset value and to adjust the first source capacitor such that a value of a second post tap converges to a second preset value. The first post tap and the second post tap are different.

### CROSS-REFERENCE TO RELATED APPLICATION

This U.S. non-provisional application claims priority under 35 U.S.C. § 119 to Korean Patent Application No. 10-2025-0035525, filed on Mar. 19, 2025, in the Korean Intellectual Property Office, the disclosure of which is incorporated by reference herein in its entirety.

### BACKGROUND

Some example embodiments of the inventive concepts relate to a receiver, and more particularly, to a receiver configured to improve the quality of a received signal by adjusting a plurality of parameters of an equalizer in real time in a high-speed data transmission system.

Electronic devices may operate independently or in communication with other electronic devices. With the advancement of technology, the amount of data transmitted between electronic devices is increasing, and data transmission speeds are also increasing.

However, due to the characteristics of a channel, distortion of data signals may occur, and this distortion may increase in high-speed data transmission and reduce the quality of data signals transmitted at high speeds. For example, data signal distortion phenomena, such as inter-symbol interference (ISI), may impact high-frequency regions of data signals. In order to eliminate or alleviate or reduce the distortion phenomena, such as the ISI, in the received data signal, the receiver may include equalizers, such as a continuous time linear equalizer (CTLE), a decision feedback equalizer (DFE), and a feed forward equalizer (FFE). It may be beneficial to adaptively adjust a plurality of parameters of the equalizers based on the characteristics of a channel and/or change in an environment (e.g., ambient temperature of a receiver) during data signal transmission.

### SUMMARY

Example embodiments of the inventive concepts provide a receiver, a method of operating the receiver, and a system including the receiver. According to some example embodiments, the receiver is configured to improve the quality of a received signal by adjusting a plurality of parameters of an equalizer in real time in a high-speed data transmission system. For example, a high-speed data transmission system may send and/or receive data at rates measured in megabits per second (Mbps) or gigabits per second (Gbps).

According to some example embodiments of the inventive concepts, a receiver includes a continuous time linear equalizer (CTLE) circuit configured to generate an equalization signal by performing first equalization on a received signal based on a first source resistor and a first source capacitor, the first source resistor and the first source capacitor being adjustable, an analog digital converter (ADC) configured to sample the equalization signal and generate a plurality of sampling symbols that are continuous and correspond to the equalization signal, a decision feedback equalizer (DFE) configured to generate a plurality of estimated symbols corresponding to the equalization signal by respectively subtracting residuals of previous sampling symbols from the plurality of sampling symbols, and a parameter adjustment circuit configured, in a first cycle based on the plurality of estimated symbols, to adjust the first source resistor such that a value of a first post tap converges to a first preset value and to adjust the first source capacitor such that a value of a second post tap converges to a second preset value, the second post tap and the first post tap being different.

According to some example embodiments of the inventive concepts, a method of operating a receiver includes generating an equalization signal by performing first equalization on a received signal based on a first source resistor and a first source capacitor, the first source resistor and the first source capacitor being adjustable, sampling the equalization signal and generating a plurality of sampling symbols that are continuous and corresponding to the equalization signal, generating a plurality of estimated symbols corresponding to the equalization signal by subtracting residuals of previous sampling symbols from the plurality of sampling symbols, adjusting, in a first cycle based on the plurality of estimated symbols, the first source resistor such that a value of a first post tap converges to 0, and adjusting, in the first cycle, the first source capacitor such that a value of a second post tap converges to 0, the second post tap and the first post tap being different.

According to some example embodiments of the inventive concepts, a system includes a transmitter configured to transmit a data signal, a channel configured to deliver the data signal transmitted from the transmitter, and a receiver configured to receive the data signal via the channel and generate an equalization signal by performing first equalization on the data signal based on a first source resistor and a first source capacitor, the first source resistor and the first source capacitor being adjustable. The receiver is configured to generate a plurality of estimated symbols corresponding to the equalization signal and is further configured, based on the plurality of estimated symbols, to adjust the first source resistor such that a value of a first post tap converges to 0 and to adjust the first source capacitor such that a value of a second post tap converges to 0, the second post tap and the first post tap being different. The first post tap is closer to a main tap than the second post tap, and the first source resistor is adjusted in a same cycle as the first source capacitor.

### BRIEF DESCRIPTION OF THE DRAWINGS

Example embodiments will be more clearly understood from the following detailed description taken in conjunction with the accompanying drawings.

FIG. 1 is a block diagram showing an electronic system according to some example embodiments.

FIG. 2 is a diagram showing distortion of reception signals according to channel characteristics.

FIG. 3A is a circuit diagram of a continuous time linear equalizer (CTLE) according to some example embodiments.

FIG. 3B is a graph showing a frequency response according to equalization of a CTLE according to some example embodiments.

FIG. 4 is a block diagram of an adjustment loop circuit according to some example embodiments.

FIG. 5 is a block diagram of a parameter adjustment circuit according to some example embodiments.

FIG. 6 is a flowchart showing an operation of a receiver according to some example embodiments.

FIG. 7 is a block diagram of an adjustment loop circuit according to some example embodiments.

FIG. 8 is a block diagram of a parameter adjustment circuit according to some example embodiments.

FIG. 9 is a block diagram of the parameter adjustment circuit of FIG. 8, according to some example embodiments.

FIG. 10 is a flowchart showing an operation of a receiver according to some example embodiments.

FIGS. 11A, 11B, 11C, and 11D are graphs showing frequency responses adjusted by operations of the receiver according to some example embodiments.

FIG. 12 is a block diagram illustrating a system including the receiver according to some example embodiments.

FIG. 13 is a block diagram illustrating a system-on-chip including the receiver according to some example embodiments.

### DETAILED DESCRIPTION OF EXAMPLE EMBODIMENTS

Hereinafter, example embodiments are described with reference to the accompanying drawings.

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

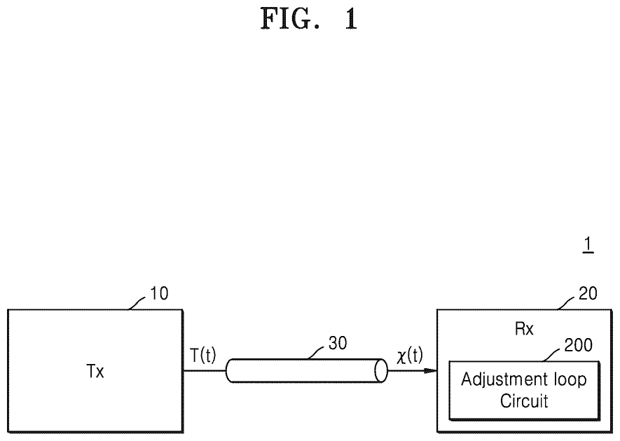

FIG. 1 is a block diagram showing an electronic system 1 according to some example embodiments.

Referring to FIG. 1, the electronic system 1 may include a transmitter 10, a receiver 20, and a channel 30 between the transmitter 10 and the receiver 20.

The transmitter 10 may transmit a transmission signal T(t) to the receiver 20 via the channel 30, and the receiver 20 may receive a reception signal x(t) via the channel 30. The channel 30 may include a signal line that physically or electrically connects the transmitter 10 to the receiver 20. Ends of the channel 30 may be coupled to respective pins of the transmitter 10 and receiver 20. The term “pin” broadly indicates electrical interconnections for integrated circuits and may include, for example, pads or other electrical contact points on an integrated circuit.

The channel 30 may be implemented by using, for example, a trace of a printed circuit board (PCB) or a coaxial cable. However, due to the skin effect and dielectric loss, high-frequency components of the data signal (e.g., the transmission signal T(t)) transmitted via the channel 30 may be attenuated. The reception signal x(t) received by the receiver 20 via the channel 30 may include distortion due to channel loss. In the channel 30, impedance mismatch may occur due to connectors and other physical interfaces between boards and cables. The impedance mismatch of the channel 30 may appear as a notch in a frequency response of the channel 30 and may cause reflection noise in the receiver 20. Each bit of the reception signal x(t) that passes through the channel 30 may affect subsequent bit(s) due to channel loss or bandwidth limitation. Also, neighboring symbols may overlap, causing an increase in bit error rate (BER), for example, inter-symbol interference (ISI), may occur. The ISI may become more prominent as the data rate increases and a corresponding decrease in pulse width representing data bits occurs. Example embodiments are described herein with reference to signal distortion caused by the ISI for ease of understanding. However, it will be understood that the receiver 20, according to some example embodiments, may eliminate or mitigate or reduce signal distortion caused by various other causes, as well as the signal distortion caused by the ISI, based on an adjustment loop circuit 200 described below. Although example embodiments are disclosed with reference to a wired channel 30, example embodiments are not limited to wired technologies and it will be understood that the present disclosure is likewise applicable to wireless or other communication technologies where it may be advantageous to improve the quality of a communication signal.

Ideally, the transmission signal T(t) transmitted from the transmitter 10 and the reception signal x(t) received by the receiver 20 should be identical to each other without any distortion of the data signal by the channel 30, but due to the influence of the channel 30 described above, the signal transmitted via the channel 30 may include distortion. Therefore, the receiver 20 may recover the reception signal x(t) and use the recovered signal.

As described above, the reception signal x(t) may be distorted by the ISI, etc., and this distortion may be particularly prominent or higher in high-frequency components. As described above, the reception signal x(t) may be distorted by the ISI, etc., and this distortion may be particularly prominent or higher in high-frequency components.

For example, the receiver 20 may include a continuous time linear equalizer (CTLE) and a decision feedback equalizer (DFE) and perform adaptive equalization based on bit and edge bits output from the equalizer to optimally open an eye diagram of signals. Accordingly, the performance of the receiver 20 and the electronic system 1 may be improved. The CTLE and the DFE are described in more detail below.

The receiver 20 may include the adjustment loop circuit 200. The adjustment loop circuit 200 according to some example embodiments of the inventive concepts may include at least one CTLE and effectively equalize the reception signal x(t) by performing background adjustment on a plurality of parameters of the CTLE. The adjustment loop circuit 200 is described in more detail below.

In some example embodiments, the receiver 20 may be used in a memory interface, a serializer/deserializer (SERDES), and the latest high-speed automotive communication.

For example, the transmitter 10 may include a host, and the receiver 20 may be or include a memory device. The host may include a central processing unit (CPU), a graphics processing unit (GPU), or an application processor (AP). The memory device may include a volatile memory device or a non-volatile memory device.

For example, the transmitter 10 may include a host, and the receiver 20 may be or include a peripheral device. The peripheral device may include a display device, a communication device, a storage device, etc.

However, example embodiments are not limited to the examples described above.

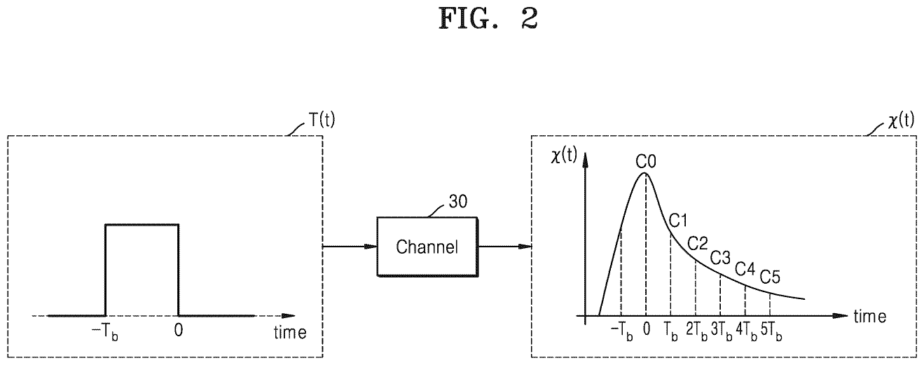

FIG. 2 is a diagram showing distortion of reception signals according to channel characteristics.

Referring to FIG. 2, when a transmitter transmits the transmission signal T(t) having a pulse width of T_{b} via the channel 30, a receiver may receive a distorted reception signal x(t) due to the influence of the channel 30 and/or an increase in data rate as described above.

For example, due to characteristics of a low-pass filter of the channel 30, the reception signal x(t) gradually rises before t=−T_{b} and reaches a main cursor C0 at t=0. The reception signal x(t) may gradually decrease from t=0, reach a first post cursor C1 at t=T_{b}, and reach a second post cursor C2 at t=2T_{b}. Referring to FIG. 2, the reception signal x(t) may not reach zero even when t=5T_{b}. Here, the post cursor includes a cursor that is located later in time than the main cursor C0 representing current data sampled at a sampling time.

The CTLE may be used to compensate for the distortion of the reception signal x(t). The CTLE may amplify the magnitude of high-frequency components of the reception signal x(t) by considering the influence of the channel 30, thereby eliminating or mitigating or reducing the distortion caused by the ISI.

Referring to FIG. 2, T_{b} may represent a unit interval (UI), and the UI may correspond to the time between two adjacent bits of an input signal. The transmission signal T(t) and the reception signal x(t) shown in FIG. 2 are provided for ease of understanding, and the example embodiments are not limited thereto.

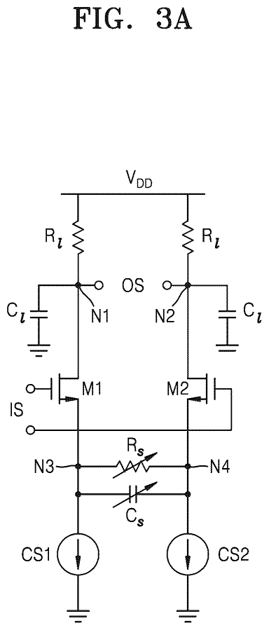

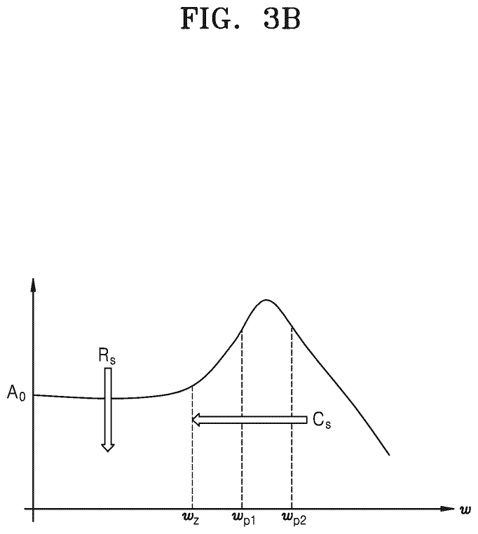

FIG. 3A is a circuit diagram of a continuous time linear equalizer (CTLE) according to some example embodiments.

In some example embodiments, the adjustment loop circuit 200 of FIG. 1 may include the continuous time linear equalizer (CTLE) of FIG. 3A. Referring to FIG. 3A, the CTLE may include a pair of transistors M1 and M2, which are connected to a power supply voltage V_{DD} via resistors Rₗ and grounded via current sources CS1 and CS2, respectively. The resistor Rₗ, a capacitor Cₗ, and the transistor M1 may be connected to each other via a first node N1, and the resistor Rₗ, a capacitor Cₗ, and the transistor M2 may be connected to each other via a second node N2. The CTLE may output an output signal OS via the nodes N1 and N2. Here, an input signal IS may represent a reception signal as described above (e.g., x(t) in FIG. 1 or x(t) in which a gain is controlled by an auto gain controller (AGC) described below), and the output signal OS may represent a signal obtained by equalizing the input signal IS through the CTLE. In some example embodiments, the current sources CS1 and CS2 (or referred to as first and second current sources CS1 and CS2) may have the same size. For example, the first current source CS1 and the second current source CS2 may include two transistors of which gates are connected to each other. However, the current sources CS1 and CS2 according to example embodiments are not limited to the examples described above.

Referring to FIG. 3A, the transistors M1 and M2 may be connected to each other via a source resistor R_{S} and a source capacitor C_{S} that are connected to each other in parallel. The transistor M1, the source resistor R_{S}, the source capacitor C_{S}, and the first current source CS1 may be connected to each other via a third node N3, and the transistor M2, the source resistor R_{S}, the source capacitor C_{S}, and the second current source CS2 may be connected to each other via a fourth node N4. The CTLE may receive the input signal IS via a gate of each of the transistor M1 and the transistor M2. Each of the source resistor R_{S} and the source capacitor C_{S} includes a variable element. For convenience of description, FIG. 3A illustrates that the source resistor R_{S} and the source capacitor C_{S} include a single resistor and a single capacitor, respectively. However, the example embodiments are not limited thereto. For example, the source resistor R_{S} may be provided as a resistor array including a plurality of resistors, and the source capacitor C_{S} may be provided as a capacitor array including a plurality of capacitors. Even in this case, the resistance value and capacitance of the source resistor R_{S} and the source capacitor C_{S} may be adjusted by switching connection relationships between the plurality of resistors and/or the plurality of capacitors, respectively.

The receiver according to some example embodiments may eliminate or mitigate or reduce the distortion of the reception signal by adaptively adjusting the resistance value of the source resistor R_{S} and/or the capacitance of the source capacitor C_{S} of the CTLE. In some example embodiments, for convenience of description, R_{S} may be referred to as a source resistor or a source resistance value, and C_{S} may be referred to as a source capacitor or source capacitance. Therefore, the receiver may be described as being capable of adjusting an adjustable source resistor (i.e., the source resistance value) and of adjusting an adjustable source capacitor (i.e., the source capacitance) of the CTLE. In other words, the receiver may improve the performance of the CTLE by adjusting the source resistor and/or the source capacitor, which is described below.

FIG. 3B is a graph showing a frequency response according to equalization of a CTLE according to some example embodiments.

FIG. 3B may be discussed with reference to FIG. 3A above.

The frequency response of CTLE may be determined according to Equation 1.

$$\begin{matrix}{A}_{0} = \frac{{g}_{m} {R}_{l}}{1 + {g}_{m} {R}_{s}} \\ {ω}_{z} = \frac{1}{{R}_{s} {C}_{s}} \\ {ω}_{p 1} = \frac{1 + {g}_{m} {R}_{s}}{{R}_{s} {C}_{s}} \\ {ω}_{p 2} = \frac{1}{{R}_{l} {C}_{l}}\end{matrix} \qquad [ Equation 1 ]$$

In equation 1, A₀ represents a DC gain of the CTLE, ω_{z} represents a frequency corresponding to zero of the frequency response of the CTLE, and ωₚ₁ and ωₚ₂ each represent a frequency corresponding to a pole of the frequency response of the CTLE. gₘ is the transconductance of transistors (M1 and M2 of FIG. 3A).

Referring to FIG. 3B, the frequency response of the CTLE may be adjusted by adjusting the source resistor (R_{S} of FIG. 3A) and/or the source capacitor (C_{S} of FIG. 3A), and thus, the signal distortion caused by the characteristics of a channel and/or a signal transmission/reception environment may be eliminated or mitigated or reduced. For example, when increasing the resistance value of the source resistor (R_{S} of FIG. 3A), the CTLE may reduce the signal gain in a low frequency band, thereby reducing the difference in signal strength between the high frequency band, which is relatively more attenuated by the channel, and the low frequency band, which is relatively less attenuated by the channel. Also, ω_{z}, ωₚ₁, and ωₚ₂ may be changed by changing the capacitance of the source capacitor (C_{S} of FIG. 3A). Accordingly, the CTLE may achieve equalization performance that is optimized for the characteristics of a given channel.

With respect to a post tap value corresponding to the resistance value of the source resistor (R_{S} of FIG. 3A) and/or the capacitance of the source capacitor (C_{S} of FIG. 3A) of the CTLE (hereinafter, referred to as CTLE parameters), the receiver, according to some example embodiments of the inventive concepts, is configured to adjust the post tap value so that the post tap value is minimized or reduced (e.g., so that the post tap value becomes less than a preset value) or so that the post tap value converges to a preset value (e.g., so that the post tap value converges to 0). For convenience of description, the CTLE parameters may be adjusted so that the post tap value corresponding to each of the CTLE parameters converges to a preset value. However, example embodiments are not limited thereto, and the receiver may adjust the CTLE parameters so that the post value is minimized or reduced.

Accordingly, the receiver may perform background adaptation of the CTLE parameters, thereby providing stable performance regardless of changes in the signal transmission and reception environment and may adjust the CTLE parameters based on the respective post tap values, thereby improving the performance of eliminating or mitigating or reducing distortion in reception signals. The tap may represent a sampling symbol at a sampling point of a channel pulse response, and the tap value may represent the value of the sampling symbol at the sampling point. The main tap may represent the largest value among the tap values, and the post tap may represent a tap that follows the main tap later in terms of time. A method of minimizing the post tap value, according to some example embodiments, is described below.

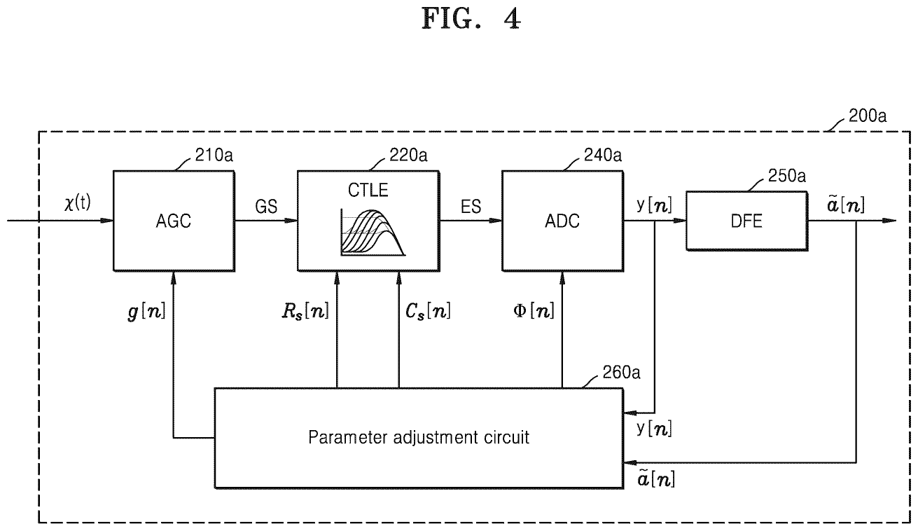

FIG. 4 is a block diagram of an adjustment loop circuit 200a according to some example embodiments. The adjustment loop circuit 200a may be the same as or similar in some respects to the adjustment loop circuit 200 in FIG. 1.

Referring to FIG. 4, the adjustment loop circuit 200a may include an auto gain controller (AGC) 210a, a CTLE 220a, an analog digital converter (ADC) or sampler 240a, a decision feedback equalizer (DFE) 250a, and a parameter adjustment circuit 260a. The CTLE 220a may be understood with reference to FIGS. 3A and 3B.

Referring to FIG. 4, the AGC 210a may output a gain adjustment signal GS by adjusting the gain of a signal based on a conditioning factor g[n]. The conditioning factor g[n] may be determined by the parameter adjustment circuit 260a. In some example embodiments, the parameter adjustment circuit 260a according to the inventive concept may adjust the conditioning factor g[n] (e.g., based on a least mean squares (LMS) method) so as to minimize the difference between an estimated symbol ã[n] and a sampling symbol y[n]. The parameter adjustment circuit 260a may transmit the adjusted conditioning factor g[n] to the AGC 210a. In some example embodiments of the inventive concepts, [n] relates to a sampling timing, and [n] may indicate that sampling is performed at a present point in time.

The CTLE 220a may perform an equalization operation on the gain adjustment signal GS based on the source resistance value R_{S}[n] and the source capacitance C_{S}[n] and may output an equalization signal ES. The equalization of the signal based on the source resistance value R_{S}[n] and the source capacitance C_{S}[n] may be understood with reference to FIGS. 3A and 3B above. The source resistance value R_{S}[n] and the source capacitance C_{S}[n] may be determined by the parameter adjustment circuit 260a.

The parameter adjustment circuit 260a according to some example embodiments may adjust the source resistance value R_{S}[n] so that a first post tap value converges to a first preset value (e.g., 0). Similarly, the parameter adjustment circuit 260a may adjust the source capacitance C_{S}[n] so that a second post tap value converges to a second preset value (e.g., 0). Here, a first post tap may be closer to the main tap than a second post tap. For example, the first post tap may be closest to the main tap, and the second post tap may be third closest to the main tap. For the purposes of discussion herein, “third closest” may indicate that there is another post tap that is farther from the main tap than the first post tap and closer to the main tap than the second post tap.

The ADC 240a may receive the equalization signal ES and sample the equalization signal ES based on a sampling phase Φ[n]. The ADC 240a may sample the equalization signal ES and generate a plurality of consecutive sampling symbols y[n]. The parameter adjustment circuit 260a may adjust the sampling phase Φ[n] based on the estimated symbol ã[n] and the sampling symbol y[n]. For example, the parameter adjustment circuit 260a may adjust the sampling phase Φ[n] by using a Mueller-Muller phase detection (MMPD) method. The ADC 240a may also be referred to as a sampler.

The DFE 250a may receive the sampling symbol y[n] and generate the estimated symbol ã[n] based on the sampling symbol y[n]. The DFE 250a may subtract the residual of a previous symbol to determine a present symbol, calibrate the sampling symbol y[n] at each of the sampling points, and generate the estimated symbol ã[n]. The tap value may correspond to the estimated symbol ã[n]. The DFE 250a may generate, based on the sampling symbol y[n], a plurality of consecutive estimated symbols ã[n] corresponding to the equalization signal ES. The estimated symbol ã[n] may represent a slicer decision symbol. For example, the DFE 250a may determine a symbol decision region based on a slicer and generate the estimated symbol ã[n]. The receiver may adjust the CTLE parameters based on the estimated symbol ã[n] and the sampling symbol y[n].

For convenience of description, the plurality of components described above are described as being included in the adjustment loop circuit 200a, but the adjustment loop circuit 200a is not limited thereto. For example, the adjustment loop circuit 200a may further include a feed forward equalizer (FFE). Also, the adjustment loop circuit 200a may omit some components (e.g., the AGC 210a) other than the CTLE 220a in the components shown in FIG. 4. Also, the ADC 240a may be included in the DFE 250a, and accordingly, the DFE 250a may receive the equalization signal ES and generate the sampling symbol y[n] and the estimated symbol ã[n].

The adjustment loop circuit 200a may further include a delay circuit for compensating for a delay that may occur in the estimated symbol ã[n] due to the DFE 250a and/or the FFE. The delay circuit may delay the sampling symbol y[n] output from the ADC 240a and may provide the delayed sampling symbol y[n] to the parameter adjustment circuit 260a. Although the delay circuit is omitted for convenience of description, the parameter adjustment circuit 260a may receive the sampling symbol y[n] delayed appropriately with respect to the estimated symbol ã[n], as described above. Therefore, in some example embodiments of the inventive concepts, the sampling symbol y[n] may represent the delayed sampling symbol y[n].

The receiver may adjust each of two CTLE parameters (the source resistance value R_{S}[n] and the source capacitance C_{S}[n]) for a single CTLE. In some example embodiments, the receiver may adjust two CTLE parameters together by adjusting one CTLE parameter based on one post tap value (i.e., so that the post tap value converges to a preset value). Accordingly, the degree of freedom of adjusting the CTLE parameters in the receiver may be increased, and thus, the performance of the CTLE may be improved. In addition, as described below, complexity may be mitigated or reduced by adjusting the CTLE parameters based on relatively simple logic. Furthermore, since interaction with a plurality of blocks that may be included in the receiver, such as the AGC and clock data recovery (CDR), may be considered, the CTLE parameter convergence and the CTLE performance may be stably achieved.

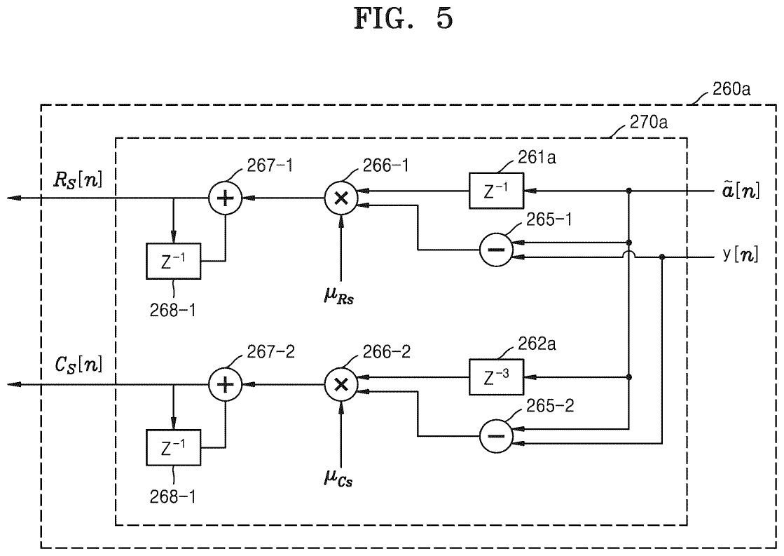

FIG. 5 is a block diagram of a parameter adjustment circuit 260a according to some example embodiments.

The parameter adjustment circuit 260a in FIG. 5 corresponds to the parameter adjustment circuit 260a in FIG. 4, and thus, repeated descriptions thereof are omitted.

Referring to FIG. 5, as described above, the parameter adjustment circuit 260a according to some example embodiments may receive the sampling symbol (y[n]) and the estimated symbol (ã[n]). The parameter adjustment circuit 260a may adjust the CTLE parameters (for example, the source resistance value R_{S}[n] and the source capacitance C_{S}[n]) based on the sampling symbol y[n] and the estimated symbol ã[n] and may transmit the adjusted CTLE parameters to the CTLE.

Furthermore, although not shown in FIG. 5 for convenience of description, it will be understood that the sampling phase Φ[n] or the like described above with reference to FIG. 4 may be adjusted and transmitted by the parameter adjustment circuit 260a.

The parameter adjustment circuit 260a according to some example embodiments may generate a CTLE parameter code to apply the adjusted source resistance value R_{S}[n] and the adjusted source capacitance C_{S}[n] to the CTLE, and based on the CTLE parameter code, the resistance value of the source resistor and/or the capacitance of the source capacitor included in the CTLE may be changed. According to the source resistance value and/or the source capacitance determined by the parameter adjustment circuit 260a, the resistance value of the source resistor and/or the capacitance of the source capacitor included in the CTLE may change. However, example embodiments are not limited to the method described above.

Referring to FIG. 5, the parameter adjustment circuit 260a may include a CTLE parameter adjustment circuit 270a. The CTLE parameter adjustment circuit 270a may include a first delay block 261a, a second delay block 262a, two subtraction blocks 265-1 and 265-2, two multiplication blocks 266-1 and 266-2, two addition blocks 267-1 and 267-2, and two delay blocks 268-1 and 268-2. A plurality of blocks in the CTLE parameter adjustment circuit 270a may be configured to adjust and output the source resistance value R_{S}[n] and the source capacitance C_{S}[n] based on the LMS method. The first delay block 261a may delay the estimated symbol ã[n] once and the second delay block 262a may delay the estimated symbol ã[n] three times. Therefore, the first delay block 261a may output the estimated symbol ã[n−1] corresponding to the first post tap value (the post tap that is closest to the main tap), and the second delay block 262a may output the estimated symbol ã[n−3] corresponding to the second post tap value (the post tap that is third closest to the main tap). The source resistance value R_{S}[n] may be adjusted according to Equation 2 below, and the source capacitance C_{S}[n] may be adjusted according to Equation 3 below.

$${R}_{s} [ n ] = {R}_{s} [ n - 1 ] + {μ}_{{R}_{s}} ( \tilde{a} [ n - 1 ] ( y [ n ] - \tilde{a} [ n ] ) ) \qquad [ Equation 2 ]$$

$${C}_{s} [ n ] = {C}_{s} [ n - 1 ] + {μ}_{{C}_{s}} ( \tilde{a} [ n - 3 ] ( y [ n ] - \tilde{a} [ n ] ) ) . \qquad [ Equation 3 ]$$

In Equation 2, μ_{Rs} represents an adaptation step for the source resistance value R_{S}[n], and in Equation 3, μ_{Cs} represents an adaptation step for the source capacitance C_{S}[n].

Referring to FIG. 5, Equation 2, and Equation 3, the CTLE parameter adjustment circuit 270a according to some example embodiments may adjust the source resistance value R_{S}[n] so that the value of the first post tap (the post tap that is closest to the main tap) converges to the first preset value (e.g., 0) and may adjust the source capacitance C_{S}[n] so that the value of the second post tap (the post tap that is third closest to the main tap) converges to the second preset value (e.g., 0). The parameter adjustment circuit 260a according to FIG. 5, Equation 2, and Equation 3 is an example, and is not limited thereto. For example, the parameter adjustment circuit 260a may adjust the source resistance value R_{S}[n] so that the value of the first post tap, which is closer to the main tap than the second post tap, converges to the first preset value, and may adjust the source capacitance C_{S}[n] so that the value of the second post tap converges to the second preset value. For example, according to some example embodiments of the inventive concepts, the post tap considered to adjust the source resistance value R_{S}[n] may be closer to the main tap than the post tap considered to adjust the source capacitance C_{S}[n]. The parameter adjustment circuit 260a according to some example embodiments may determine a post tap that is considered to adjust each of the source resistance value R_{S}[n] and the source capacitance C_{S}[n] according to the bandwidth of a system. The first preset value and the second preset value according to some example embodiments may be equal to each other, but example embodiments are not limited thereto.

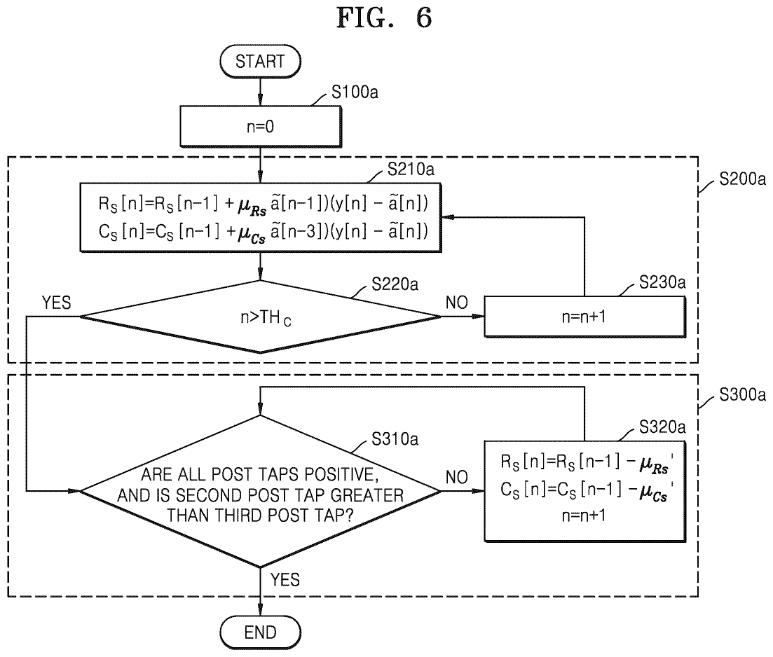

The adjustments of the source resistance value R_{S}[n] and the source capacitance C_{S}[n] described above may be performed during a single cycle (or a single loop) in the CTLE parameter adjustment circuit 270a. Therefore, the source resistance value R_{S}[n] and the source capacitance C_{S}[n] may be adjusted during the same cycle. The CTLE parameter adjustment circuit 270a may repeatedly adjust the source resistance value R_{S}[n] and the source capacitance C_{S}[n] by repeating the operation described above during an adjustment period including a plurality of cycles (i.e., by repeating cycles or repeating loops). The receiver according to some example embodiments may repeat the adjustments of the source resistance value R_{S}[n] and the source capacitance C_{S}[n] until a condition (S220a of FIG. 6) is satisfied, which is described below with reference to FIG. 6.

The first delay block 261a, the second delay block 262a, the two subtraction blocks 265-1 and 265-2, the two multiplication blocks 266-1 and 266-2, the two addition blocks 267-1 and 267-2, and the two delay blocks 268-1 and 268-2 may include at least one logic element configured to perform delay, subtraction, multiplication, and addition of symbols.

FIG. 6 is a flowchart showing an operation of a receiver according to some example embodiments. It is understood that additional operations can be provided before, during, and after the operations in FIG. 6, and some of the operations described below can be replaced or eliminated, for additional embodiments of the method. The order of the operations/processes may be interchangeable, or two or more operations can be performed simultaneously.

FIG. 6 is described with reference to FIG. 5, and therefore may be best understood with reference thereto.

The receiver according to some example embodiments may receive a reception signal (reception signal x(t)) in operation S100a. The reception signal may be sampled based on the sampling phase as described above. The reception signal may generate a sampled symbol and an estimated symbol via equalization and sampling.

In operation S200a, the receiver may intermediately adjust each of the source resistance value R_{S}[n] and the source capacitance C_{S}[n]. In operation S300a, the receiver may finally adjust (e.g., output a final value of) each of the source resistance value R_{S}[n] and the source capacitance C_{S}[n]. In some example embodiments of the inventive concepts, unless otherwise specified, ‘adjustment’ represents an ‘intermediate adjustment’ or a ‘final adjustment.’

Referring to FIG. 6, operation S200a may include operation S210a of intermediately adjusting each of the source resistance value R_{S}[n] and the source capacitance C_{S}[n] according to Equation 2 and Equation 3 described above with reference to FIG. 5, operation S220a of determining whether n is greater than a predetermined (or desired or given) threshold value TH_{C}, and operation S230a of increasing n by 1 when n is less than the predetermined threshold value TH_{C}. When n is greater than the predetermined threshold value TH_{C}, the receiver may perform operation S300a of updating each of the source resistance value R_{S}[n] and the source capacitance C_{S}[n]. In operation S220a, the receiver may perform minimal adaptation on each of the source resistance value R_{S}[n] and the source capacitance C_{S}[n].

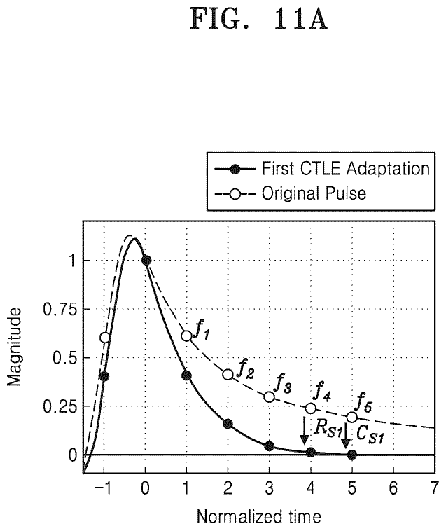

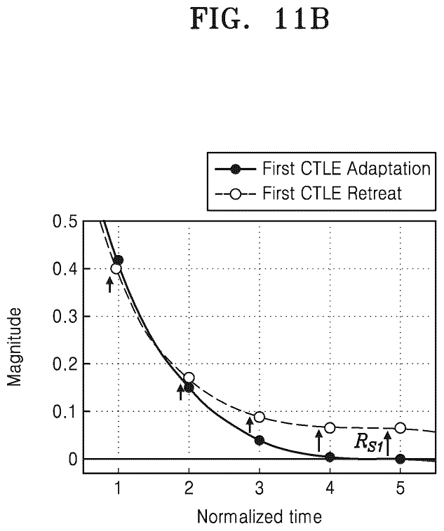

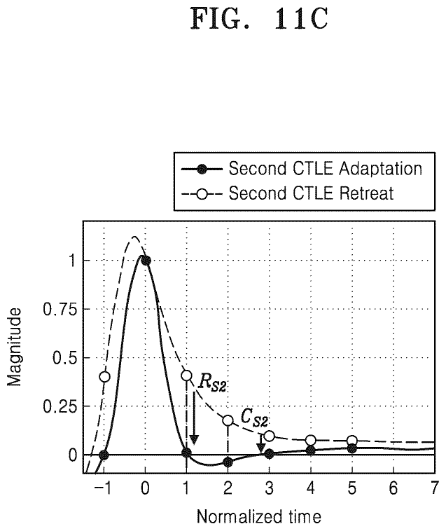

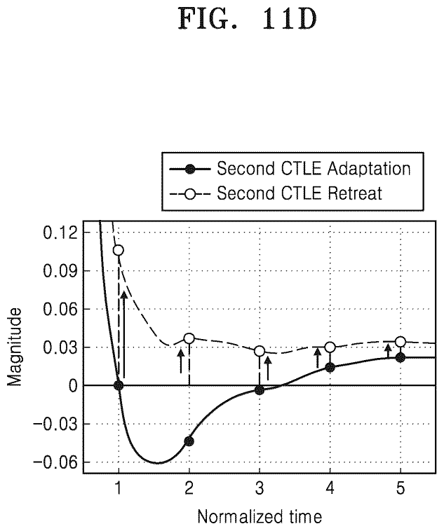

Referring to FIG. 6, operation S300a may include determining whether all post taps are positive and determining whether the post tap value, which is second closest to the main tap, is greater than the post tap value, which is third closest to the main tap (S310a). The operation S300a may further include retreating or reducing each of the source resistance value R_{S}[n] and the source capacitance C_{S}[n] and increasing n by 1 when all post taps are not positive or the post tap value, which is second closest to the main tap, is less than the post tap value, which is third closest to the main tap (S320a). The post tap to be determined in operation S300a represents the post tap adjusted corresponding to the source resistance value R_{S}[n] and the source capacitance C_{S}[n] that have been intermediately adjusted according to the result of operation S220a. Embodiments of the adjusted post tap according to the adjustment of the source resistance value R_{S}[n] and the source capacitance C_{S}[n] are shown in FIG. 11A and FIG. 11C.

$${μ}_{Rs}^{′} and {μ}_{Cs}^{′}$$

In operation S320a, represent the retreat steps for the source resistance value R_{S}[n] and the source capacitance C_{S}[n], respectively. When all post taps are positive and the post tap value, which is second closest to the main tap, is greater than the post tap value, which is third closest to the main tap, the source resistance value, and the source capacitance of the CTLE may be finally adjusted based on the present source resistance value R_{S}[n] and the present source capacitance C_{S}[n], respectively. The receiver may perform the retreat described above so as to restore the smoothness of the pulse response according to the adjustments of the source resistance value R_{S}[n] and the source capacitance C_{S}[n].

The receiver according to some example embodiments may repeat operations S100a to S320a based on the adjusted source resistance value R_{S}[n] and the adjusted source capacitance C_{S}[n]. Accordingly, the receiver may adjust the source resistance value R_{S}[n] so that the first post tap (e.g., the post tap that is closest to the main tap) described above with reference to FIG. 5 converges to the first preset value and may adjust the source capacitance C_{S}[n] so that the second post tap (e.g., the post tap that is third closest to the main tap) converges to the second preset value.

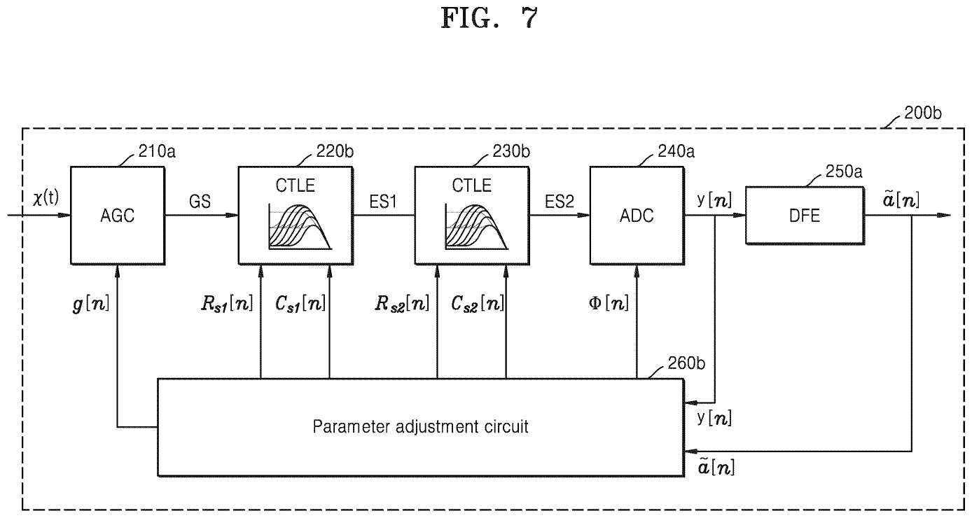

FIG. 7 is a block diagram of an adjustment loop circuit 200b according to some example embodiments.

The adjustment loop circuit 200b in FIG. 7 may be the same as or similar in some respects to the adjustment loop circuit 200a in FIG. 4, and therefore may be best understood with reference thereto where like numerals indicate like elements not described again in detail. As illustrated, the adjustment loop circuit 200b includes two CTLEs 220b and 230b (or referred to as first and second CTLEs 220b and 230b). The first CTLE 220b and the second CTLE 230b are discussed below.

Referring to FIG. 7, the first CTLE 220b may perform an equalization operation (first equalization) on the gain adjustment signal GS based on a first source resistance value R_{S1}[n] and first source capacitance C_{S1}[n] and then output a first equalization signal ES1. The equalization operation of the first CTLE 220b based on the first source resistance value R_{S1}[n] and the first source capacitance C_{S1}[n] may be understood by the descriptions given above for the adjustment loop circuit 200a, and thus, may be best understood with reference thereto. The first source resistance value R_{S1}[n] and the first source capacitance C_{S2}[n] may be determined by a parameter adjustment circuit 260b.

Similar to the description above with reference to FIG. 4, the parameter adjustment circuit 260b according to some example embodiments may adjust the first source resistance value R_{S1}[n] so that the first post tap value converges to the first preset value. Similarly, the parameter adjustment circuit 260b may adjust the first source capacitance C_{S1}[n] so that the second post tap value converges to the second preset value. Here, the first post tap may be closer to the main tap than the second post tap. For example, the first post tap may be closest to the main tap, and the second post tap may be third closest to the main tap.

Referring to FIG. 7, the second CTLE 230b may perform an equalization operation (second equalization) on the first equalization signal ES1 based on a second source resistance value R_{S2}[n] and second source capacitance C_{S2}[n] and then output a second equalization signal ES2. As shown in FIG. 7, when the equalization operations are performed by using a plurality of CTLEs, more precise equalization may be performed on distorted signals by using different frequency responses (see FIGS. 3A and 3B). The equalization operation of the second CTLE 230b based on the second source resistance value R_{S2}[n] and the second source capacitance C_{S2}[n] may be understood by the descriptions given above, and thus, the description thereof is omitted. The second source resistance value R_{S2}[n] and the second source capacitance C_{S2}[n] may be determined by the parameter adjustment circuit 260b.

The parameter adjustment circuit 260b according to some example embodiments may adjust the second source resistance value R_{S2}[n] so that a third post tap value converges to a third preset value. Also, the parameter adjustment circuit 260b may adjust the second source capacitance C_{S2}[n] so that a fourth post tap value converges to a fourth preset value. Here, a third post tap may be closer to the main tap than a fourth post tap. For example, the third post tap may be fourth closest to the main tap, and the fourth post tap may be fifth closest to the main tap.

For convenience of description, it is described with reference to FIG. 7 that the receiver includes two CTLEs 220b and 230b, but the CTLE according to some example embodiments may include three or more CTLEs. For a receiver including three or more CTLEs, the receiver may adjust CTLE parameters so that a post tap corresponding to each of the CTLE parameters (the source resistance value and the source capacitance) for each of the CTLEs converges to a preset value. Also, FIG. 7 illustrates that the receiver includes two CTLEs 220b and 230b that are independent of each other, but this is for convenience of description. The two CTLEs 220b and 230b may be implemented as a single CTLE circuit, and the two CTLEs 220b and 230b may be referred to as a CTLE circuit.

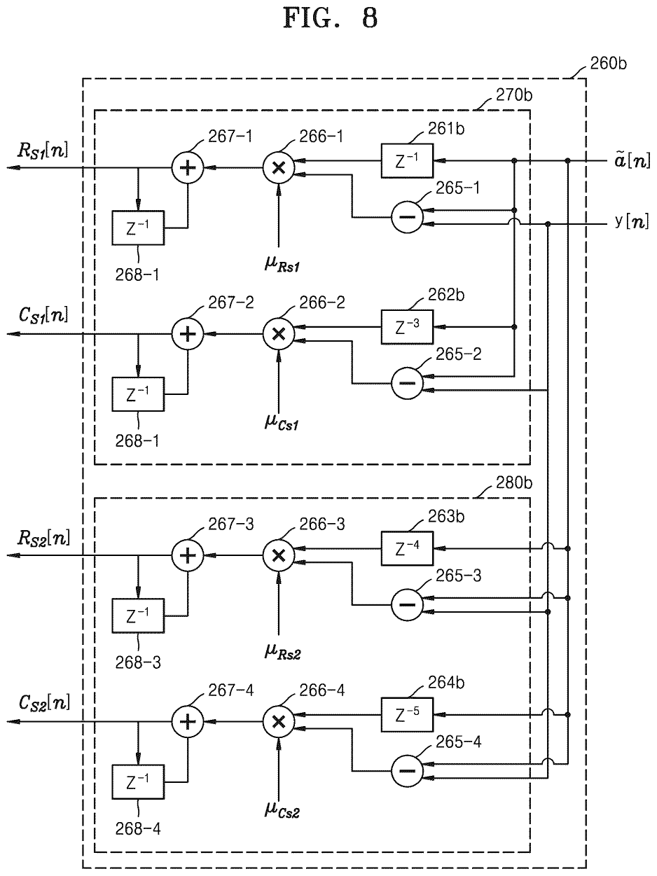

FIG. 8 is a block diagram of a parameter adjustment circuit 260b according to some example embodiments.

The parameter adjustment circuit 260b of FIG. 8 may be the same as or similar in some respects to the parameter adjustment circuit 260b of FIG. 7, and thus, may be best understood with reference thereto where like numerals indicate like elements not described again in detail. Also, the parameter adjustment circuit 260b in FIG. 8 includes a first CTLE parameter adjustment circuit 270b and a second CTLE parameter adjustment circuit 280b. The first CTLE parameter adjustment circuit 270b may be the same as or similar in some respects to the CTLE parameter adjustment circuit 270a of FIG. 5 and therefore may be best understood with reference thereto. Also, the second CTLE parameter adjustment circuit 280b may be the same as or similar in some respects to the CTLE parameter adjustment circuit 270a of FIG. 5 and therefore may be best understood with reference thereto. The first delay block 261a and the second delay block 262a in the CTLE parameter adjustment circuit 270a may be replaced by a third delay block 263b and a fourth delay block 264b, respectively. Therefore, repeated descriptions thereof are omitted.

Referring to FIG. 8, the first CTLE parameter adjustment circuit 270b may include a first delay block 261b, a second delay block 262b, the two subtraction blocks 265-1 and 265-2, the two multiplication blocks 266-1 and 266-2, the two addition blocks 267-1 and 267-2, and the two delay blocks 268-1 and 268-2. μ_{Rs1} represents an adaptation step for the first source resistance value R_{S1}[n], and μ_{Cs1} represents an adaptation step for the first source capacitance C_{S1}[n]. The operation of the first CTLE parameter adjustment circuit 270b to adjust the first source resistance value R_{S1}[n] and the first source capacitance C_{S1}[n] may be the same as or similar in some respects to the operation described above with reference to FIG. 5, and therefore may be best understood with reference thereto.

Referring to FIG. 8, the second CTLE parameter adjustment circuit 280b may include the third delay block 263b, the fourth delay block 264b, two subtraction blocks 265-3 and 265-4, two multiplication blocks 266-3 and 266-4, two addition blocks 267-3 and 267-4, and two delay blocks 268-3 and 268-4. The third delay block 263b may delay the estimated symbol ã[n] four times, and the fourth delay block 264b may delay the estimated symbol ã[n] five times. Therefore, the third delay block 263b may output the estimated symbol ã[n−4] corresponding to the third post tap value (the post tap that is fourth closest to the main tap), and the fourth delay block 264b may output the estimated symbol ã[n−5] corresponding to the fourth post tap value (the post tap that is fifth closest to the main tap). The second source resistance value R_{S2}[n] may be adjusted according to Equation 4 below, and the second source capacitance C_{S2}[n] may be adjusted according to Equation 5 below.

$${R}_{s 2} [ n ] = {R}_{s 2} [ n - 1 ] + {μ}_{R s 2} \tilde{a} [ n - 4 ] ( y [ n ] - \tilde{a} [ n ] ) \qquad [ Equation 4 ]$$

$${C}_{s 2} [ n ] = {C}_{s 2} [ n - 1 ] + {μ}_{C s 2} \tilde{a} [ n - 5 ] ( y [ n ] - \tilde{a} [ n ] ) \qquad [ Equation 5 ]$$

In Equation 4, μ_{Rs2} represents an adaptation step for the second source resistance value R_{S2}[n], and in Equation 5, μ_{Cs2} represents an adaptation step for the second source capacitance C_{S2}[n].

The second CTLE parameter adjustment circuit 280b according to FIG. 8, Equation 4, and Equation 5 is an example, and is not limited thereto. For example, the second CTLE parameter adjustment circuit 280b may adjust the second source resistance value R_{S2}[n] so that the value of the third post tap, which is closer to the main tap than the fourth post tap, converges to the third preset value (e.g., 0) and adjust the second source capacitance (C_{S2}[n]) so that the value of the fourth post tap converges to the fourth preset value (e.g., 0). According to some example embodiments of the inventive concepts, the post tap considered to adjust the second source resistance value R_{S2}[n] may be closer to the main tap than the post tap considered to adjust the second source capacitance C_{S2}[n]. The parameter adjustment circuit 260b according to some example embodiments may determine a post tap that is considered to adjust each of the two CTLE parameters of each of the two CTLEs according to the bandwidth of a system. The third preset value and the fourth preset value may be equal to each other, but example embodiments are not limited thereto.

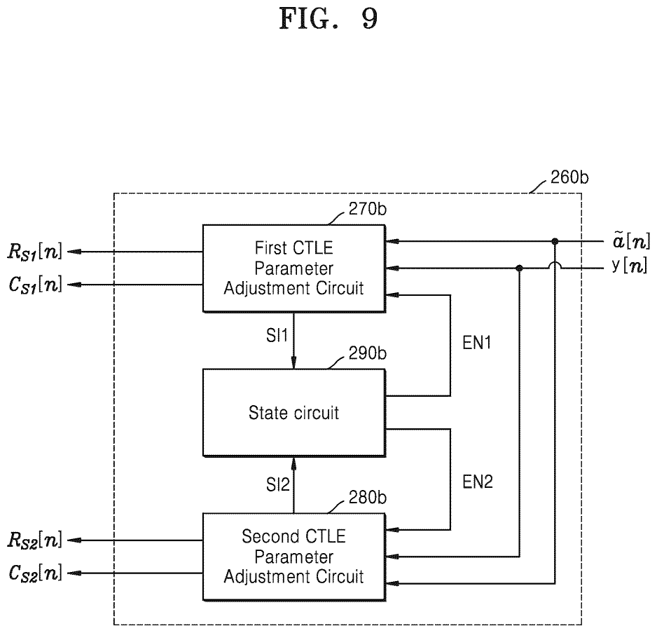

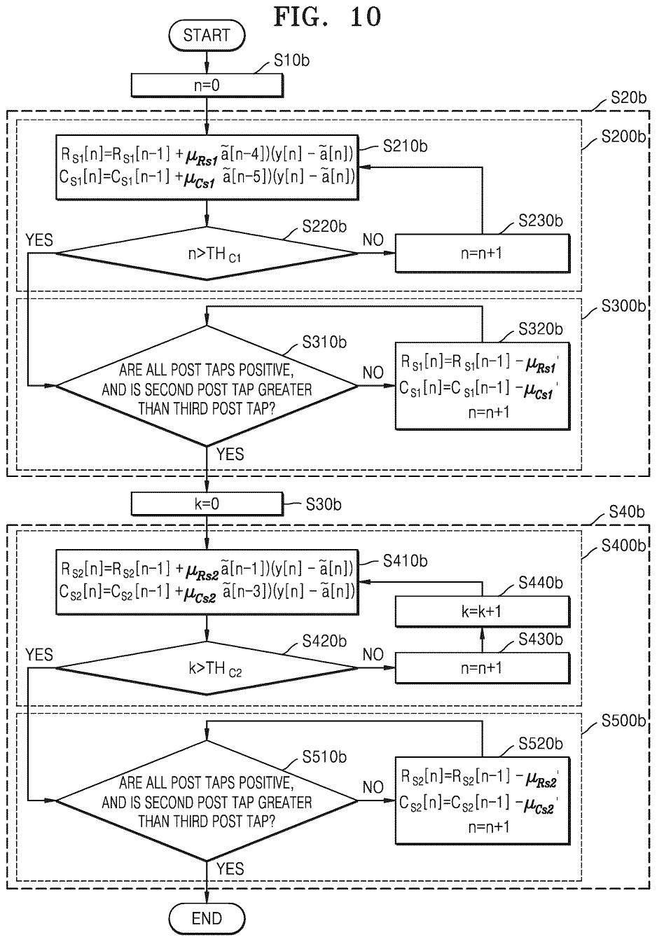

The first CTLE parameter adjustment circuit 270b and the second CTLE parameter adjustment circuit 280b may adjust the CTLE parameters for each of the first CTLE (220b of FIG. 7) and the second CTLE (230b of FIG. 7) sequentially, rather than adjusting the CTLE parameters simultaneously. The CTLE parameter adjustment operations of the first CTLE parameter adjustment circuit 270b and the second CTLE parameter adjustment circuit 280b may affect each other, and thus, for stable convergence of the CTLE parameters, the first CTLE parameter adjustment circuit 270b and the second CTLE parameter adjustment circuit 280b may sequentially adjust the CTLE parameters of each of the first CTLE (220b of FIG. 7) and the second CTLE (230b of FIG. 7). This operation is described below with reference to FIGS. 9 and 10.

FIG. 9 is a block diagram of the parameter adjustment circuit 260b of FIG. 8, according to some example embodiments.

A parameter adjustment circuit 260b, a first CTLE parameter adjustment circuit 270b, and a second CTLE parameter adjustment circuit 280b of FIG. 9 correspond to the parameter adjustment circuit 260b, the first CTLE parameter adjustment circuit 270b, and the second CTLE parameter adjustment circuit 280b of FIG. 8, respectively, and therefore may be best understood with reference thereto where like numerals indicate like elements not described again in detail.

Referring to FIG. 9, a state circuit 290b may receive first state information SI1 from the first CTLE parameter adjustment circuit 270b and second state information SI2 from the second CTLE parameter adjustment circuit 280b. The first state information SI1 may include the number of adjustments (or referred to as a cycle number) of the first CTLE parameter adjustment circuit 270b and the post tap values according to the adjusted CTLE parameters of the first CTLE (e.g., 220b of FIG. 7). Similarly, the second state information SI2 may include the number of adjustments (or referred to as a cycle number) of the second CTLE parameter adjustment circuit 280b and the post tap values according to the adjusted CTLE parameters of the second CTLE (e.g., 230b of FIG. 7).

The state circuit 290b may transmit a second enable signal EN2 to the second CTLE parameter adjustment circuit 280b based on the first state information SI1 and may transmit a first enable signal EN1 to the first CTLE parameter adjustment circuit 270b based on the second state information SI2.

In some example embodiments, the state circuit 290b may transmit the first enable signal EN1 to the first CTLE parameter adjustment circuit 270b, and the first CTLE parameter adjustment circuit 270b may adjust, based on the first enable signal EN1, the CTLE parameters (e.g., the first source resistance value R_{S1}[n] and the first source capacitance C_{S1}[n] described with reference to FIG. 8) of the first CTLE (e.g., 220b of FIG. 7). The first CTLE parameter adjustment circuit 270b may adjust the CTLE parameters of the first CTLE (e.g., 220b of FIG. 7) until the number of adjustments exceeds a predetermined (or desired or given) first threshold value TH_{C1}. In this case, the state circuit 290b may transmit the first enable signal EN1 to the first CTLE parameter adjustment circuit 270b until the number of adjustments exceeds the predetermined first threshold value. The first CTLE parameter adjustment circuit 270b may transmit, to the state circuit 290b, the first state information SI1 that includes the number of adjustments and a plurality of post tap values according to the most recently adjusted CTLE parameters. The state circuit 290b may determine, based on the first state information SI1, whether all post taps are positive and whether the post tap value, which is second closest to the main tap, is greater than the post tap value, which is third closest to the main tap. When the state circuit 290b determines that the post taps in the first state information SI1 are positive and the post tap value, which is second closest to the main tap, is greater than the post tap value, which is third closest to the main tap, the first enable signal EN1 may not be output, and the second enable signal EN2 may be transmitted to the second CTLE parameter adjustment circuit 280b.

The second CTLE parameter adjustment circuit 280b may receive the second enable signal EN2, and the second CTLE parameter adjustment circuit 280b may adjust, based on the second enable signal EN2, the CTLE parameters (e.g., the second source resistance value R_{S2}[n] and the second source capacitance C_{S2}[n] described with reference to FIG. 8) of the second CTLE (e.g., 230b of FIG. 7). The second CTLE parameter adjustment circuit 280b may adjust the CTLE parameters of the second CTLE (e.g., 230b of FIG. 7) until the number of adjustments exceeds a predetermined (or desired or given) second threshold value. In some example embodiments, the state circuit 290b may transmit the second enable signal EN2 to the second CTLE parameter adjustment circuit 280b until the number of adjustments exceeds the predetermined second threshold value. The second CTLE parameter adjustment circuit 280b may transmit, to the state circuit 290b, the second state information SI2 that includes the number of adjustments and a plurality of post tap values according to the most recently adjusted CTLE parameters. The state circuit 290b may determine, based on the second state information SI2, whether all post taps are positive and whether the post tap value, which is second closest to the main tap, is greater than the post tap value, which is third closest to the main tap. When the state circuit 290b determines that the post taps in the second state information SI2 are positive and the post tap value, which is second closest to the main tap, is greater than the post tap value, which is third closest to the main tap, the second enable signal EN2 may not be output, and the first enable signal EN1 may be transmitted to the first CTLE parameter adjustment circuit 270b.

As described above, in the receiver according to some example embodiments of the inventive concepts, the first CTLE parameter adjustment circuit 270b and the second CTLE parameter adjustment circuit 280b may adjust the CTLE parameters for each of the first CTLE 220b and the second CTLE 230b sequentially, rather than adjusting the CTLE parameters simultaneously. Stated otherwise, a first adjustment period during which the first source resistance value R_{S1}[n] and the first source capacitance C_{S1}[n] are adjusted repeatedly does not overlap a second adjustment period during which the second source resistance value R_{S2}[n] and the second source capacitance C_{S2}[n] are adjusted repeatedly.

Referring to FIG. 9, the CTLE parameters of the first CTLE 220b are adjusted, based on the first enable signal EN1 output from the state circuit 290b, by the first CTLE parameter adjustment circuit 270b, and then, the CTLE parameters of the second CTLE 230b are adjusted, based on the second enable signal EN2, by the second CTLE parameter adjustment circuit 280b. Also, in some example embodiments, these adjustments may be repeated. However, example embodiments of the inventive concepts are not limited thereto, and in the receiver, the CTLE parameters of the second CTLE 230b may be adjusted by the second CTLE parameter adjustment circuit 280b, and then, the CTLE parameters of the first CTLE 220b may be adjusted by the first CTLE parameter adjustment circuit 270b. Also, these adjustments may be repeated.

The receiver may include a plurality of CTLEs, and the parameter adjustment circuit in the receiver may sequentially adjust the CTLE parameters for each of the plurality of CTLEs.

FIG. 10 is a flowchart showing an operation of a receiver according to some example embodiments.

FIG. 10 may be best understood by the description given above with reference to FIGS. 8 and 9. Therefore, repeated descriptions thereof may be omitted for the sake of brevity. The flowchart of FIG. 10 may be best understood with reference to the flowchart of FIG. 6, and descriptions of operations that are the same as or similar to those in the flowchart of FIG. 6 may be omitted.

Referring to FIG. 10,

$${μ}_{Rs 1}^{′}$$

represents a retreat step for the first source resistance value R_{S1}[n], and

$${μ}_{Cs 1}^{′}$$

represents a retreat step for the first source capacitance C_{S1}[n]. Similarly,

$${μ}_{Rs 2}^{′}$$

represents a retreat step for the second source resistance value R_{S2}[n], and

$${μ}_{Cs 2}^{′}$$

represents a retreat step for the second source capacitance C_{S2}[n].

Referring to FIG. 10, in operation S10b, the receiver may receive a reception signal. The reception signal may be sampled based on the sampling phase as described above. The reception signal may generate a sampled symbol and an estimated symbol via equalization and sampling.

In operation S20b, the receiver may adjust each of the first source resistance value R_{S1}[n] and the first source capacitance C_{S1}[n]. In operation S30b, the receiver may adjust each of the second source resistance value R_{S2}[n] and the second source capacitance C_{S2}[n]. As described above with reference to FIG. 9, the receiver according to some example embodiments may adjust the second source resistance value R_{S2}[n] and the second source capacitance C_{S2}[n] and then adjust the first source resistance value R_{S1}[n] and the first source capacitance C_{S1}[n].

Operations S200b and S300b in operation S20b, operations S210b, S220b, and S230b in operation S200b, and operations S310b and S320b in operation S300b may be understood based on the intermediate adjustment and the final adjustment (including the retreat step) of the CTLE parameters which are described above with reference to FIGS. 6 and 9. Therefore, detailed descriptions thereof are omitted.

In operation S30b, the receiver may initialize k (e.g., k=0), which represents the number of adjustments for the second source resistance value R_{S2}[n] and the second source capacitance C_{S2}[n]. Operation S400b may include performing operations S410b, S420b, and S430b. Operations S410b, S420b, and S430b may be best understood based on the intermediate adjustment and the final adjustment (including the retreat step) of the CTLE parameters described above with reference to FIGS. 6 and 9, and, therefore, detailed descriptions thereof are omitted herein for the sake of brevity. In operation S440b (performed after operation S430b), k may be increased by 1 each time an adjustment is performed. Also, in operation S420b, k may be compared to the predetermined second threshold value TH_{C2}, and it may be determined whether k is greater than the second threshold value TH_{C2}. When k is less than the second threshold value TH_{C2}, operation S430b may be performed. Operation S440b and operation S420b may be understood as operations for performing minimum adaptation on the second source resistance value R_{S2}[n] and the second source capacitance C_{S2}[n].

When k is greater than the second threshold value TH_{C2}, operation S510b of the operation S500b may be performed. Operations S510b and S520b in operation S500b may be understood based on the intermediate adjustment and the final adjustment (including the retreat step) of the CTLE parameters described above with reference to FIGS. 6 and 9, and, therefore, detailed descriptions thereof are omitted herein for the sake of brevity.

FIGS. 11A, 11B, 11C, and 11D are graphs showing frequency responses adjusted by operations of the receiver according to some example embodiments.

Each of FIGS. 11A and 11B is a graph showing the change in the post tap values according to the adaptation of the first source resistance value R_{S1}[n] and the first source capacitance C_{S1}[n] described above with reference to operation S20b of FIG. 10 or the retreat of the first source resistance value R_{S1}[n] and the first source capacitance C_{S1}[n] according to the post tap values.

Also, each of FIGS. 11C and 11D is a graph showing the change in the post tap values according to the adaptation of the second source resistance value R_{S2}[n] and the second source capacitance C_{S2}[n] described above with reference to operation S40b of FIG. 10 or the retreat of the second source resistance value R_{S2}[n] and the second source capacitance C_{S2}[n] according to the post tap values.

As shown in FIGS. 11A to 11D, the retreat operation of the receiver according to some example embodiments of the inventive concepts is to prevent or limit the adaptation operation of one CTLE from unnecessarily affecting the adaptation operation of the other CTLEs. For example, when the retreat operation is not performed, at least two CTLEs may infinitely equalize distortion caused by each other, which may prevent or limit the value of the post tap from converging to the preset value (e.g., 0) or may lead to inaccurate results.

Accordingly, each of FIGS. 11A, 11B, 11C, and 11D may be understood by the description given above with reference to FIG. 10.

FIGS. 11A through 11D illustrate sequential CTLE parameter adjustment including parameter adaptation stages and retreat stages according to some example embodiments of the present disclosure, in order to address control instability issues that may occur when adjusting a first CTLE and a second CTLE. Referring to FIG. 11A, a stage of updating parameters of the first CTLE to reduce inter-symbol interference (ISI) is illustrated. The receiver may estimate a pulse response from a received signal and control an operation of the first CTLE based on ISI tap coefficients included in the estimated pulse response. In FIG. 11A, f1, f2, f3, f4, and f5 represent post tap coefficients that sequentially appear on a time axis after a main tap. For example, f1 represents a first post tap immediately following the main tap, and f2 through f5 represent post taps that are progressively farther away in time from the main tap. Each of the post tap coefficients may reflect a magnitude and a sign of residual ISI at a corresponding delay position. In FIG. 11A, an “Original Pulse” represents a pulse response before parameter adjustment of the first CTLE, and a “First CTLE Adaptation” represents a pulse response after parameters of the first CTLE are adjusted. The receiver may adjust parameters of the first CTLE based on long-tail post taps (e.g., f4 and f5) observed in the Original Pulse. FIG. 11B illustrates a retreat (or reduce) stage performed after the adjustment of the first CTLE. The receiver may retreat or reduce parameter values in a predetermined, desired or given direction such that adjustment of the second CTLE may be performed in a stable manner by reshaping the pulse response. For example, the receiver may relax equalization characteristics formed (e.g., excessively formed) due to the adjustment of the first CTLE, such that the post taps satisfy a predetermined, desired or given condition (e.g., a non-negative condition). Through this retreat or reducing operation, mutual interference between a plurality of CTLEs may be suppressed, reduced or lowered. FIG. 11C illustrates a stage of updating parameters of the second CTLE based on post taps located adjacent to the main tap, for example, f1 and f3. The second CTLE may have characteristics for compensating a relatively high-frequency band, and a pulse response may be reshaped such that ISI occurring in a region immediately following the main tap is reduced. FIG. 11D illustrates a retreat (or reducing) stage performed after the adjustment of parameters of the second CTLE. The receiver may retreat or reduce the adjusted parameter values such that parameter adjustment of the first CTLE may be performed again in a subsequent cycle with relatively improved stability.

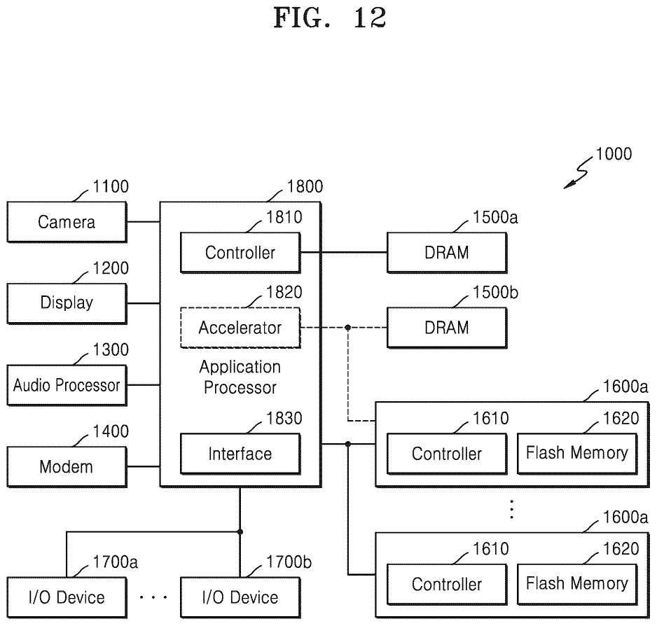

FIG. 12 is a block diagram illustrating a system 1000 including the receiver according to some example embodiments.

Referring to FIG. 12, the system 1000 may include a camera 1100, a display 1200, an audio processor 1300, a modem 1400, dynamic random-access memories (DRAMs) 1500a and 1500b, flash memories 1600a and 1600b, input/output (I/O) devices 1700a and 1700b, and an application processor (AP) 1800. The system 1000 may be implemented as a laptop computer, a mobile phone, a smartphone, a tablet personal computer (PC), a wearable device, a healthcare device, or an Internet of Things (IoT). In addition, the system 1000 may be implemented as a server or a PC.

The camera 1100 may capture still images or moving images under control by a user, and store the captured image/video data or transmit the captured image/video data to the display 1200. The audio processor 1300 may process audio data contained in contents of the flash memories 1600a and 1600b or a network. For transmission and reception of wired/wireless data, the modem 1400 may modulate a signal and transmit the modulated signal, and the modulated signal may be demodulated and restored to the original signal on a reception side. The I/O devices 1700a and 1700b may include devices that provide digital input and/or output functions, such as a universal serial bus (USB) or storage, a digital camera, a secure digital (SD) card, a digital versatile disc (DVD), a network adapter, and a touch screen.

The AP 1800 may control overall operations of the system 1000. The AP 1800 may control the display 1200 so that contents stored in the flash memories 1600a and 1600b are displayed on the display 1200. When a user input is received via the I/O devices 1700a and 1700b, the AP 1800 may perform a control operation in response to the user input. The AP 1800 may include an accelerator block, which is a dedicated circuit for artificial intelligence (AI) data computation, or may be provided with an accelerator chip 1820 that is separate from the accelerator block. The accelerator block or the accelerator chip 1820 may be further equipped with the DRAM 1500b. An accelerator represents a function block specialized in performing a particular function of the AP 1800, and the accelerator may include a GPU that is a function block specialized in processing graphic data, a neural processing unit (NPU) that is a block specialized in performing AI computation and inference, and a data processing unit (DPU) that is a block specialized in data transmission.

The system 1000 may include a plurality of DRAMs 1500a and 1500b. The AP 1800 may control the DRAMs 1500a and 1500b by setting a mode register (MRS) and commands conforming to Joint Electron Device Engineering Council (JEDEC) standards, or may perform communication by establishing DRAM interface protocols to utilize vendor-specific functions, such as low voltage/high speed/reliability, and cyclic redundancy check (CRC)/error correction code (ECC) functions. For example, the AP 1800 may communicate with the DRAM 1500a over an interface conforming to JEDEC standards, such as low power double data rate 4th generation (LPDDR4) and low power double data rate 5th generation (LPDDR5), and the accelerator block or the accelerator chip 1820 may perform communication by establishing a new DRAM interface protocol to control the DRAM 1500b for an accelerator that has a higher bandwidth than the DRAM 1500a.

Only the DRAMs 1500a and 1500b are shown in FIG. 12, but example embodiments are not limited thereto. Any memory, such as phase-change random access memory (PRAM), static random-access memory (SRAM), magnetic random-access memory (MRAM), resistive random-access memory (ReRAM), ferroelectric random-access memory (FRAM), and hybrid RAM, may be used as long as the memory satisfies the bandwidth, the response speed, and the voltage requirements of the AP 1800 or the accelerator chip 1820. The DRAMs 1500a and 1500b have relatively less latency and bandwidth than the I/O devices 1700a and 1700b or the flash memories 1600a and 1600b. The DRAMs 1500a and 1500b are initialized at a point in time when the system 1000 is powered on, and an operating system and application data are loaded in the DRAMs 1500a and 1500b. The DRAMs 1500a and 1500b may be used as temporary storage spaces for the operating system and the application data or as execution spaces for various pieces of software code.

Arithmetic operations, such as addition, subtraction, multiplication, and division, vector operations, address operations, or fast Fourier transform (FFT) operations may be performed in the DRAMs 1500a and 1500b. In addition, a function for execution used for inference may be performed inside the DRAMs 1500a and 1500b. Here, the inference may be performed in a deep learning algorithm using an artificial neural network. The deep learning algorithm may include a training stage of training a model by using various pieces of data and an inference stage of identifying data by using the trained model. In some example embodiments, the images captured by the user via the camera 1100 are signal-processed and stored in the DRAM 1500b, and the accelerator block or the accelerator chip 1820 may perform AI data calculation in which data is identified by using the data stored in the DRAM 1500b and the functions used in the inference.

The system 1000 may include a plurality of storages or the plurality of flash memories 1600a and 1600b having larger capacities than the DRAMs 1500a and 1500b. The accelerator block or the accelerator chip 1820 may perform the training stage and the AI data calculation by using the flash memories 1600a and 1600b. In some example embodiments, the flash memories 1600a and 1600b may use a calculation device provided in a memory controller 1610 and enable the AP 1800 and/or the accelerator chip 1820 to perform the training stage and the inference AI data calculation more efficiently. The flash memories 1600a and 1600b may store images captured by the camera 1100 or store data transmitted via a data network. For example, augmented reality (AR)/virtual reality (VR), high definition (HD), or ultra high definition (UHD) contents may be stored therein.

For high-speed data transmission and reception between components, the system 1000 according to some example embodiments of the inventive concepts may include at least one CTLE and a parameter adjustment circuit configured to perform background adaptation on CTLE parameters. In the system 1000, the camera 1100, the display 1200, the audio processor 1300, the modem 1400, the DRAMs 1500a and 1500b, the flash memories 1600a and 1600b, the I/O devices 1700a and 1700b, and/or the AP 1800 may include the receiver described above with reference to FIGS. 2 to 11.

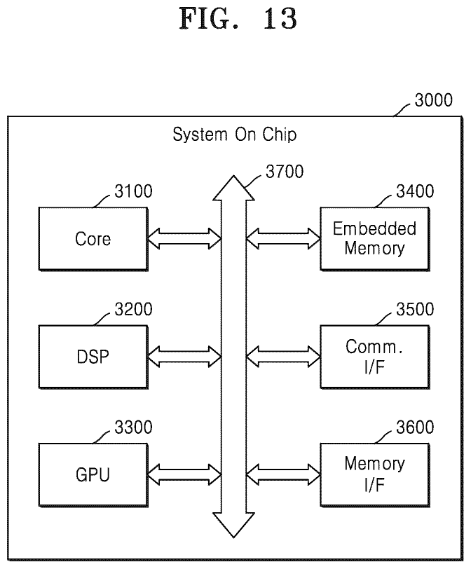

FIG. 13 is a block diagram illustrating a system-on-chip (SoC) 3000 including the receiver according to some example embodiments.

An SoC may represent an integrated circuit in which components of a computing system or other electronic systems are integrated with each other. For example, an application processor (AP) as an example of the SoC may include a processor and components for other functions.

Referring to FIG. 13, the SoC 3000 may include a core 3100, a digital signal processor (DSP) 3200, a GPU 3300, an embedded memory 3400, a communication interface 3500, and a memory interface 3600. Components of the SoC 3000 may communicate with each other via a bus 3700.

The core 3100 may process commands and may control operations of the components included in the SoC 3000. For example, the core 3100 may drive an operating system and run applications on the operating system, by processing a series of commands. The DSP 3200 may generate data by processing digital signals, for example, digital signals provided from the communication interface 3500. The GPU 3300 may generate data for an image, which is output on a display device from image data provided from the embedded memory 3400 or the memory interface 3600, and may also encode the image data. The embedded memory 3400 may store data for the core 3100, the DSP 3200, and the GPU 3300 to operate. The memory interface 3600 may provide an interface to external memory of the SoC 3000, such as DRAM and flash memory.

The communication interface 3500 may provide serial communication with the outside of the SoC 3000. For example, the communication interface 3500 may be connected to Ethernet and may include a SERDES for serial communication, or may be connected to other wired or wireless communication technologies.

Also, the receiver according to some example embodiments may include the communication interface 3500 and/or the memory interface 3600 and may also include at least one CTLE and a parameter adjustment circuit for performing background adaptation on CTLE parameters so as to eliminate or mitigate or reduce distortion of the received signal. The communication interface 3500 and/or the memory interface 3600 may adjust the CTLE parameters according to the configurations and methods according to some example embodiments disclosed above, and may eliminate or mitigate or reduce distortion of the received signal based on the CTLE parameters.

As described herein, any devices, systems, modules, portions, units, controllers, circuits, and/or portions thereof according to any of the example embodiments, and/or any portions thereof (including, without limitation, the electronic system 1, the transmitter 10, the receiver 20, the adjustment loop circuit 200, the adjustment loop circuit 200a, the automatic gain controller (AGC) 210a, the CTLE 220a, the analog digital converter (ADC) or sampler 240a, the decision feedback equalizer (DFE) 250a, the parameter adjustment circuit 260a, the first and second CTLEs 220b and 230b, the parameter adjustment circuit 260b, the first CTLE parameter adjustment circuit 270b, the second CTLE parameter adjustment circuit 280b, the state circuit 290b, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a programmable logic unit, a microprocessor, an application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A receiver comprising:
a continuous time linear equalizer (CTLE) circuit configured to generate an equalization signal by performing first equalization on a received signal based on a first source resistor and a first source capacitor, the first source resistor and the first source capacitor being adjustable;
an analog digital converter (ADC) configured to sample the equalization signal and generate a plurality of sampling symbols that are continuous and correspond to the equalization signal;
a decision feedback equalizer (DFE) configured to generate a plurality of estimated symbols corresponding to the equalization signal by respectively subtracting residuals of previous sampling symbols from the plurality of sampling symbols; and
a parameter adjustment circuit configured, in a first cycle based on the plurality of estimated symbols, to adjust the first source resistor such that a value of a first post tap converges to a first preset value and to adjust the first source capacitor such that a value of a second post tap converges to a second preset value, the second post tap and the first post tap being different.

2. The receiver of claim 1, wherein the first post tap is closer to a main tap than the second post tap.

3. The receiver of claim 2, wherein the first post tap is closest to the main tap, and the second post tap is third closest to the main tap.

4. The receiver of claim 1, wherein the CTLE circuit is further configured to generate the equalization signal by performing second equalization on the received signal based on a second source resistor and a second source capacitor, the second source resistor and the second source capacitor being adjustable, and
the parameter adjustment circuit is further configured, in a second cycle, based on the plurality of estimated symbols, to adjust the second source resistor such that a value of a third post tap converges to a third preset value and to adjust the second source capacitor such that a value of a fourth post tap converges to a fourth preset value, the first cycle and the second cycle being different.

5. The receiver of claim 4, wherein the first post tap is closer to a main tap than the second post tap and the third post tap is closer to the main tap than the fourth post tap.

6. The receiver of claim 5, wherein the first post tap is closest to the main tap, the second post tap is third closest to the main tap, the third post tap is fourth closest to the main tap, and the fourth post tap is fifth closest to the main tap.

7. The receiver of claim 4, wherein the parameter adjustment circuit is configured to intermediately adjust the first source resistor and the first source capacitor by repeating cycles of a first threshold value or more during a first adjustment period, the first adjustment period comprising the first cycle, and
the parameter adjustment circuit is configured to intermediately adjust the second source resistor and the second source capacitor by repeating cycles of a second threshold value or more during a second adjustment period, the second adjustment period comprising the second cycle,
wherein the second adjustment period and the first adjustment period are non-overlapping.

8. The receiver of claim 7, wherein the parameter adjustment circuit is further configured to finally adjust the first source resistor and the first source capacitor by retreating the first source resistor and the first source capacitor that have been intermediately adjusted,
wherein each value of a plurality of post taps according to the first source resistor and the first source capacitor that have been intermediately adjusted is positive, and a value of a post tap, which is second closest to a main tap, among the plurality of post taps is greater than a value of a post tap, which is third closest to the main tap, among the plurality of post taps.

9. A method of operating a receiver, the method comprising:
generating an equalization signal by performing first equalization on a received signal based on a first source resistor and a first source capacitor, the first source resistor and the first source capacitor being adjustable;
sampling the equalization signal and generating a plurality of sampling symbols that are continuous and corresponding to the equalization signal;
generating a plurality of estimated symbols corresponding to the equalization signal by subtracting residuals of previous sampling symbols from the plurality of sampling symbols;
adjusting, in a first cycle based on the plurality of estimated symbols, the first source resistor such that a value of a first post tap converges to 0; and
adjusting, in the first cycle, the first source capacitor such that a value of a second post tap converges to 0, the second post tap and the first post tap being different.

10. The method of claim 9, wherein the first post tap is closer to a main tap than the second post tap.

11. The method of claim 10, wherein the first post tap is closest to the main tap, and the second post tap is third closest to the main tap.

12. The method of claim 9, wherein the generating the equalization signal further comprises:
performing second equalization on the received signal based on a second source resistor and a second source capacitor, the second source resistor and the second source capacitor being adjustable;
adjusting, in a second cycle and based on the plurality of estimated symbols, the second source resistor such that a value of a third post tap converges to 0, the second cycle being different from the first cycle; and
adjusting, in the second cycle, the second source capacitor so that a value of a fourth post tap converges to 0.

13. The method of claim 12, wherein the first post tap is closer to a main tap than the second post tap and the third post tap is closer to the main tap than the fourth post tap.

14. The method of claim 13, wherein the first post tap is closest to the main tap, the second post tap is third closest to the main tap, the third post tap is fourth closest to the main tap, and the fourth post tap is fifth closest to the main tap.

15. The method of claim 12, wherein the second cycle is provided after the first cycle, and
the method further comprises retreating, between the first cycle and the second cycle, the first source resistor and the first source capacitor that have been adjusted, wherein each value of a plurality of post taps according to the first source resistor and the first source capacitor that have been adjusted is positive, and a value of a post tap, which is second closest to a main tap, among the plurality of post taps is greater than a value of a post tap, which is third closest to the main tap, among the plurality of post taps.

16. A system comprising:
a transmitter configured to transmit a data signal;
a channel configured to deliver the data signal transmitted from the transmitter; and
a receiver configured to receive the data signal via the channel and generate an equalization signal by performing first equalization on the data signal based on a first source resistor and a first source capacitor, the first source resistor and the first source capacitor being adjustable,
wherein the receiver is configured to generate a plurality of estimated symbols corresponding to the equalization signal and is further configured, based on the plurality of estimated symbols, to adjust the first source resistor such that a value of a first post tap converges to 0 and to adjust the first source capacitor such that a value of a second post tap converges to 0, the second post tap and the first post tap being different, wherein the first post tap is closer to a main tap than the second post tap,
and the first source resistor is adjusted in a same cycle as the first source capacitor.

17. The system of claim 16, wherein the receiver is configured to generate the equalization signal by further performing second equalization on the data signal based on a second source resistor and a second source capacitor, the second source resistor and the second source capacitor being adjustable, and
the receiver is further configured, based on the plurality of estimated symbols, to adjust the second source resistor such that a value of a third post tap converges to 0 and to adjust the second source capacitor such that a value of a fourth post tap converges to 0, the third post tap and the fourth post tap being different,
wherein the third post tap is closer to the main tap than the fourth post tap, and the second source resistor is adjusted in a same cycle as the second source capacitor.

18. The system of claim 17, wherein the first post tap is closest to the main tap, the second post tap is third closest to the main tap, the third post tap is fourth closest to the main tap, and the fourth post tap is fifth closest to the main tap.

19. The system of claim 17, wherein the receiver is configured to intermediately adjust the first source resistor and the first source capacitor by repeating cycles of a first threshold value or more during a first adjustment period, and
the receiver is configured to intermediately adjust the second source resistor and the second source capacitor by repeating cycles of a second threshold value or more during a second adjustment period,
wherein the second adjustment period and the first adjustment period are non-overlapping.

20. The system of claim 19, wherein the receiver is configured to finally adjust the first source resistor and the first source capacitor by retreating, between the first adjustment period and the second adjustment period, the first source resistor and the first source capacitor that have been intermediately adjusted,
wherein each value of a plurality of post taps according to the first source resistor and the first source capacitor that have been intermediately adjusted is positive, and a value of a post tap, which is second closest to the main tap, among the plurality of post taps is greater than a value of a post tap, which is third closest to the main tap, among the plurality of post taps.
